(19) United States
(12) Patent Application Publication
(10) Pub. No.: US 2025/0209656 A1
(43) Pub. Date: Jun. 26, 2025

(54) METHOD AND SYSTEM FOR CALCULATING LEAF AREA OF PLANT AND ELECTRONIC DEVICE

(71) Applicant: ZHEJIANG UNIVERSITY OF SCIENCE & TECHNOLOGY, Hangzhou City (CN)

(72) Inventors: Xing XU, Hangzhou City (CN); Yun ZHAO, Hangzhou City (CN); Yuan YANG, Hangzhou City (CN)

(21) Appl. No.: 18/918,949

(22) Filed: Oct. 17, 2024

(30) Foreign Application Priority Data
Dec. 25, 2023 (CN) 202311785078.4

(51) Int. Cl. G06T 7/62; G01C 21/20; G06T 7/149; G06V 10/774; G06V 10/80; G06V 20/10

(52) U.S. Cl. CPC G06T 7/62; G01C 21/20; G06T 7/149; G06V 10/774; G06V 10/806; G06V 20/188

(57) ABSTRACT

Provided is a method, system, and electronic device for calculating a leaf area of a plant, relating to the field of image processing. The method includes: obtaining a leaf image of a target plant on a planned path, where the planned path is a path determined based on a dynamic window approach (DWA) path planning algorithm; segmenting the leaf image by using a UNet model to obtain a leaf segmentation image, where the UNet model includes an encoder, a decoder, and a trained segmentation network that are connected to each other; and calculating a leaf area based on the leaf segmentation image. This application can achieve rapid and accurate segmentation of leaf images and calculation of leaf areas.

### CROSS REFERENCE TO RELATED APPLICATION

This patent application claims the benefit and priority of Chinese Patent Application No. 2023117850784, filed with the China National Intellectual Property Administration on Dec. 25, 2023, the disclosure of which is incorporated by reference herein in its entirety as part of the present application.

### TECHNICAL FIELD

The present disclosure relates to the field of image processing, and in particular, to a method and system for calculating a leaf area of a plant and an electronic device.

### BACKGROUND

Currently, the measurement of leaf areas of dwarf plants mostly relies on traditional measurement methods. These traditional methods are not only slow but also lack accuracy in measurement.

The development of artificial intelligence counting has brought faster planning speeds for mobile robot path planning. The advancement of deep learning technology has increased the speed and accuracy of image segmentation, coupled with hardware devices, enabling the intelligent completion of the entire process from extracting plant feature data to segmentation. However, the crucial issue that technical personnel urgently need to address is how to use artificial intelligence methods to achieve rapid and accurate segmentation of the leaf area and subsequently calculate the leaf area.

### SUMMARY

An objective of the present disclosure is to provide a method and system for calculating a leaf area of a plant and an electronic device, to achieve rapid and accurate segmentation of leaf images and calculation of leaf areas.

To achieve the above objective, the present disclosure provides the following technical solutions.

A method for calculating a leaf area of a plant, including:
obtaining a leaf image of a target plant on a planned path, where the planned path is a path determined based on a dynamic window approach (DWA) path planning algorithm;
segmenting the leaf image by using a UNet model, to obtain a leaf segmentation image, where the UNet model includes an encoder, a decoder, and a trained segmentation network that are connected to each other; and
calculating a leaf area based on the leaf segmentation image.

Optionally, the leaf image is an RGB image captured by using an RGB camera mounted on a target robot.

Optionally, a process for determining the planned path includes:
determining a travel route of the target robot, where the travel route is determined by a line connecting a starting point and a target point;
obtaining travel data of the target robot on the travel route in real time in a form of a dynamic window, where the travel data includes obstacle position data, a travel direction, and a travel speed;
determining a trajectory function based on the DWA path planning algorithm; and
determining the planned path based on the travel data and the trajectory function.

Optionally, an expression of the trajectory function is as follows:

$$G ( v , w ) = σ ( α * heading ( v , w ) + β * d ist ( v , w ) + γ * velocity ( v , w ) ) ;$$

where G(v, w) is the trajectory function; v is the travel speed; w is an angular velocity of travel; σ is a first weight coefficient; α is a second weight coefficient; β is a third weight coefficient; γ is a fourth weight coefficient; heading(v, w) is an azimuth function; velocity(v, w) is a linear velocity of the target robot; and dist(v, w) is a distance from the target robot to an obstacle.

Optionally, the segmenting the leaf image by using the UNet model to obtain the leaf segmentation image specifically includes:
extracting, by the encoder, features of the leaf image, to obtain image feature information;
performing, by the decoder, data fusion based on the image feature information, to obtain fused feature data; and
segmenting, by the trained segmentation network, the fused feature data, to obtain the leaf segmentation image.

Optionally, a process for determining the UNet model includes:
obtaining training data, where the training data includes: leaf images for training and leaf segmentation images corresponding to the leaf images for training;
extracting, by the encoder, features from the leaf images for training, to obtain image feature information for training;
performing data fusion based on the image feature information for training, to obtain fused feature data for training;
constructing a segmentation network;
inputting the fused feature data for training into the segmentation network, updating and optimizing model parameters by using a stochastic gradient descent method with an objective of minimizing a loss value, to obtain a trained segmentation network, where the model parameters include weight values; the loss value is determined using a cross-entropy loss function based on a difference between output data of the segmentation network and the leaf segmentation images corresponding to the leaf images for training; and
connecting the encoder, the decoder, and the trained segmentation network to form the UNet model.

Optionally, the calculating a leaf area based on the leaf segmentation image specifically includes:
extracting a contour of the leaf segmentation image to obtain a leaf contour;
converting the leaf contour into a binary image;
performing morphological processing on the binary image, removing noise, and eliminating a blank area, to obtain a processed image;
performing connected component analysis on the processed image to obtain a leaf region; and
determining the leaf area based on the obtained leaf region.

A system for calculating a leaf area of a plant, including:
an image obtaining module, configured to obtain a leaf image of a target plant on a planned path, where the planned path is a path determined based on a DWA path planning algorithm;
a segmentation module, configured to segment the leaf image by using a UNet model, to obtain a leaf segmentation image; and
a calculation module, configured to calculate a leaf area based on the leaf segmentation image.

An electronic device is provided, including a memory and a processor, where the memory is configured to store a computer program, and the processor runs the computer program to enable the electronic device to execute the foregoing method for calculating the leaf area of a plant.

Optionally, the memory is a computer-readable storage medium.

According to the specific embodiments provided by the present disclosure, the present disclosure provides the following technical effects:

The present disclosure provides a method, system, and electronic device for calculating a leaf area of a plant. The method includes: obtaining a leaf image of a target plant on a planned path; segmenting the leaf image by using a UNet model to obtain a leaf segmentation image; and calculating a leaf area based on the leaf segmentation image. The speed of plant image capture can be improved since the planned path is determined based on a DWA path planning algorithm. Additionally, the UNet model, including an encoder, a decoder, and a trained segmentation network that are connected to each other, can extract rich feature information, obtain accurate leaf information, and enhance accuracy, thereby achieving rapid and accurate segmentation of leaf images and calculation of leaf areas.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can still be derived from these accompanying drawings by those of ordinary skill in the art without creative efforts.

FIG. 1 is a flowchart of a method for calculating a leaf area of a plant according to an embodiment of the present disclosure;

FIG. 2 is a schematic structural diagram of a method for calculating a leaf area of a plant according to an embodiment of the present disclosure;

FIGS. 3A-3C are schematic diagrams of a coefficient control rule table for a DWA algorithm according to an embodiment of the present disclosure, where FIG. 3A is a schematic diagram of a control rule table for a second weight coefficient α; FIG. 3B is a schematic diagram of a control rule table for a fourth weight coefficient γ; FIG. 3C is a schematic diagram of a control rule table for a third weight coefficient β;

FIG. 4 is a schematic diagram of a UBlock according to an embodiment of the present disclosure; and

FIG. 5 is a schematic diagram of a UNet according to an embodiment of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a method, system, and electronic device for calculating a leaf area of a plant, to achieve rapid and accurate segmentation of leaf images and calculation of leaf areas.

In order to make the above objective, features and advantages of the present disclosure clearer and more comprehensible, the present disclosure will be further described in detail below in combination with the accompanying drawings and the specific implementations.

### Embodiment 1

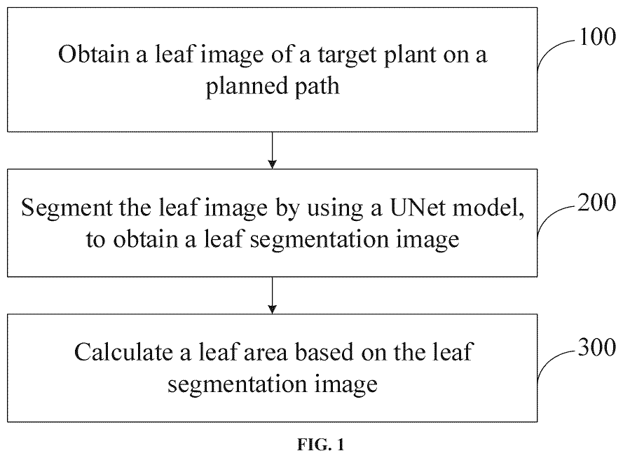

As shown in FIG. 1, this embodiment of the present disclosure provides a method for calculating a leaf area of a plant, including the following steps.

Step 100: Obtain a leaf image of a target plant on a planned path. The planned path is a path determined based on a DWA path planning algorithm.

Specifically, the leaf image is an RGB image captured by using an RGB camera mounted on a target robot.

A process for determining the planned path includes:
determining a travel route of the target robot, where the travel route is determined by a line connecting a starting point and a target point; obtaining travel data of the target robot on the travel route in real time in a form of a dynamic window, where the travel data includes obstacle position data, a travel direction, and a travel speed; determining a trajectory function based on the DWA path planning algorithm; and determining the planned path based on the travel data and the trajectory function.

An expression of the trajectory function is as follows:

$$G ( v , w ) = σ ( α * heading ( v , w ) + β * d ist ( v , w ) + γ * velocity ( v , w ) ) .$$

where G(v, w) is the trajectory function; v is the travel speed; w is an angular velocity of travel; σ is a first weight coefficient; α is a second weight coefficient; β is a third weight coefficient; γ is a fourth weight coefficient; heading(v, w) is an azimuth function; velocity(v, w) is a linear velocity of the target robot; and dist(v, w) is a distance from the target robot to an obstacle.

Step 200: Segment the leaf image by using a UNet model, to obtain a leaf segmentation image. The UNet model includes an encoder, a decoder, and a trained segmentation network that are connected to each other.

Optionally, the step of segmenting the leaf image by using the UNet model to obtain the leaf segmentation image specifically includes:
extracting features of the leaf image by using the encoder to obtain image feature information; performing data fusion based on the image feature information by using the decoder to obtain fused feature data; and segmenting the fused feature data by using the trained segmentation network to obtain the leaf segmentation image.

A process for determining the UNet model includes:
obtaining training data, where the training data includes: leaf images for training and leaf segmentation images corresponding to the leaf images for training; extracting features from the leaf images for training by using an encoder, to obtain image feature information for training; performing data fusion based on the image feature information for training, to obtain fused feature data for training; constructing a segmentation network; inputting the fused feature data for training into the segmentation network, updating and optimizing model parameters by using a stochastic gradient descent method with an objective of minimizing a loss value, to obtain a trained segmentation network, where the model parameters include weight values; the loss value is determined using a cross-entropy loss function based on a difference between output data of the segmentation network and the leaf segmentation images corresponding to the leaf images for training.

The encoder, the decoder, and the trained segmentation network are connected to each other to form the UNet model.

Step 300: Calculate a leaf area based on the leaf segmentation image.

The step of calculating the leaf area based on the leaf segmentation image specifically includes:
extracting a contour of the leaf segmentation image to obtain a leaf contour; converting the leaf contour into a binary image; performing morphological processing on the binary image, removing noise, and eliminating a blank area, to obtain a processed image; performing connected component analysis on the processed image to obtain a leaf region; and determining the leaf area based on the obtained leaf region.

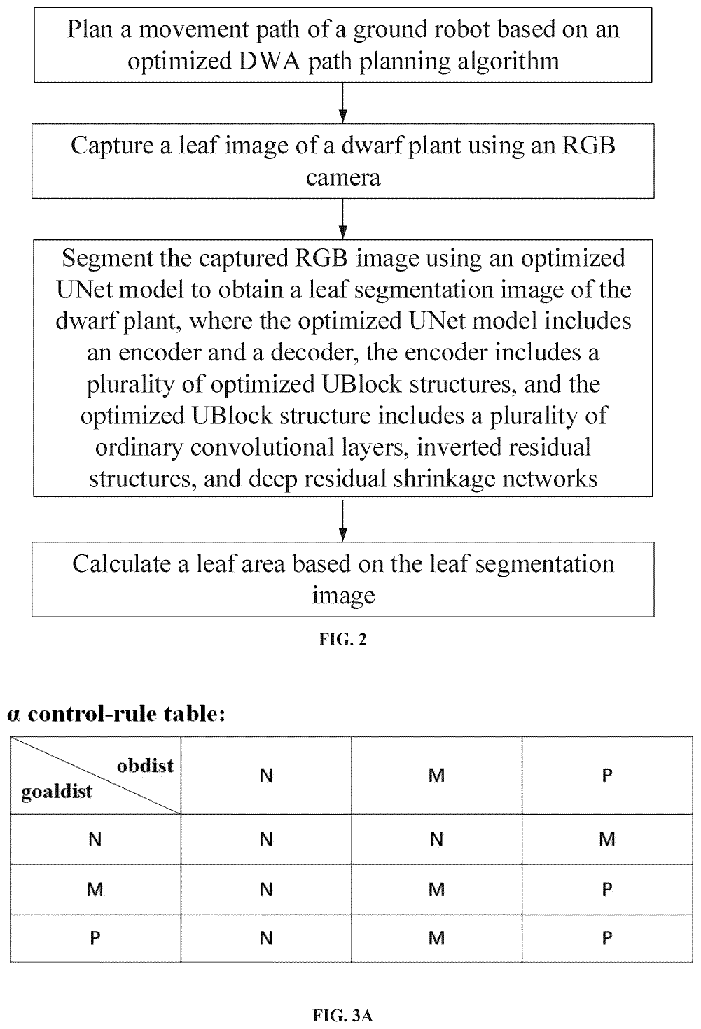

As shown in FIG. 2, in a practical application, the method provided by the present disclosure specifically includes the following steps:

A movement path of a ground robot is planned based on an optimized DWA path planning algorithm; a leaf image of a dwarf plant is captured by using an RGB camera, that is, the leaf image of the dwarf plant is captured by using an RGB camera mounted on the ground robot.

The captured RGB image is segmented using an optimized UNet model to obtain a leaf segmentation image of the dwarf plant, where the optimized UNet model includes an encoder and a decoder, the encoder includes a plurality of optimized UBlock structures, and the optimized UBlock structure includes a plurality of ordinary convolutional layers, inverted residual structures, and deep residual shrinkage networks.

The leaf area is calculated based on the leaf segmentation image. Specifically, the leaf contour is converted into a binary image; morphological processing is performed on the binary image, and noise and unnecessary areas are removed; connected component analysis is performed on the processed image to obtain a leaf region; and area of the leaf region is calculated.

The step of planning the movement path of the ground robot based on the optimized DWA path planning algorithm includes: constructing a new method for calculating evaluation function coefficients.

The UNet model performs training and segmentation on captured RGB images. The training and segmentation process includes: annotating the captured images; calculating loss values between predicted results and ground truth results using a cross-entropy loss function; back-propagating the loss values to update model parameters, and repeating the training process; and segmenting a target image using trained weights.

The optimized UBlock structure constructs a multi-branch network structure using a plurality of ordinary convolutional layers, inverted residual structures, and deep residual shrinkage networks. The encoder includes a plurality of ordinary convolutional layers and global max-pooling layers. The decoder includes a plurality of ordinary convolutional layers.

Specifically, the optimized DWA path planning algorithm significantly improves the efficiency of path planning compared to traditional methods, addressing issues related to path time and length.

Specifically, there are many local path planning methods for robots, where the dynamic window approach is mainly used in ROS. The dynamic window approach mainly samples multiple sets of velocities in velocity space and simulates trajectories of the robot at these velocities within a certain period of time. The simulated trajectories are evaluated and the velocity corresponding to the optimal trajectory is selected to drive the robot. The DWA algorithm is a dynamic window-based path planning algorithm that allows the robot to maintain velocity and direction stability while avoiding obstacles. A trajectory evaluation function of the DWA algorithm, expressed as the trajectory function, includes:

$$G ( v , w ) = σ ( α * heading ( v , w ) + β * d ist ( v , w ) + γ * velocity ( v , w ) ) .$$

heading(v, w) is an azimuth function, evaluating an angle difference between a trajectory endpoint direction and a target point under a current set speed of the robot.

dist(v, w) primarily indicates a distance of the target robot to the nearest obstacle on the map when at a predicted trajectory endpoint position. It penalizes sample points close to obstacles to ensure obstacle avoidance capability of the robot and reduce the probability of collision between the target robot and obstacles.

velocity(v, w) represents a linear speed of the target robot, aiming to facilitate the robot to quick arrival at the target.

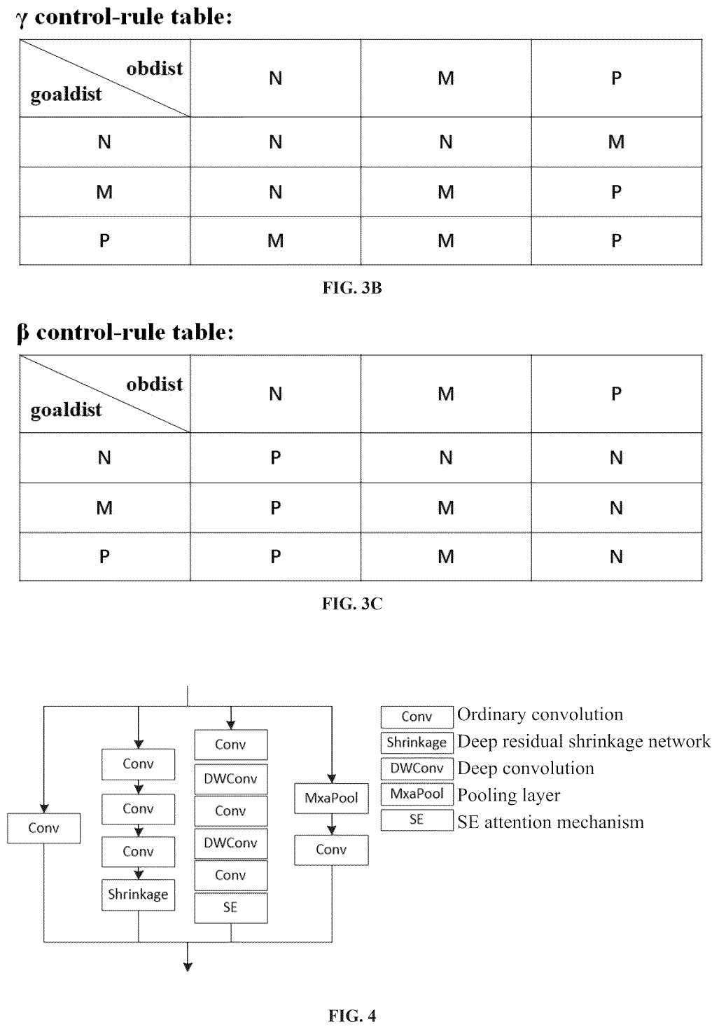

The present disclosure dynamically adjusts the values of α, β, and γ using a new rule. The new rule primarily relies on two parameters: goaldist and obdist, where goaldist represents a distance from a current point to the target point, while obdist represents a distance from the current point to the obstacle. When the current point is far from both the obstacle and the target point (that is, when obdist and goaldist have large values), the weight of velocity(v, w) can be adjusted timely to drive the target robot to arrive at the target faster. Conversely, when the current point is close to the obstacle, the weight of dist(v, w) needs adjustment. Based on this, a new rule table is designed for α, β, and γ, as shown in FIGS. 3A-3C. FIG. 3A is a schematic diagram of a control rule table for the second weight coefficient α; FIG. 3B is a schematic diagram of a control rule table for the fourth weight coefficient γ; and FIG. 3C is a schematic diagram of a control rule table for the third weight coefficient β. In FIGS. 3A-3C, N, M, and P represent three different distance levels (low, medium, and high), where a higher level indicates a greater distance from the current point to the target point or obstacle. Therefore, by dynamically adjusting the values of α, β, and γ based on the positional relationships of the current point with the target point and obstacle, the path planning algorithm can efficiently generate an effective path.

Compared to manual on-site plant image capture, robot image capture can significantly enhance the speed of image capture.

Specifically, the ground robot can increase the speed of plant image capture. Equipped with an RGB camera, the ground robot follows a travel route planned by a path planning algorithm, capturing leaf images of the plant along the way.

In contrast to the complex feature extraction process in traditional algorithms, an image feature extraction module based on deep learning can efficiently extract features from an image, such as color, texture, and shape of the image. For calculation of the leaf area, a multi-layer image feature extraction module extracts rich feature information to obtain accurate leaf information.

The optimized UBlock structure constructs a multi-branch network structure using a plurality of ordinary convolutional layers, inverted residual structures, and deep residual shrinkage networks.

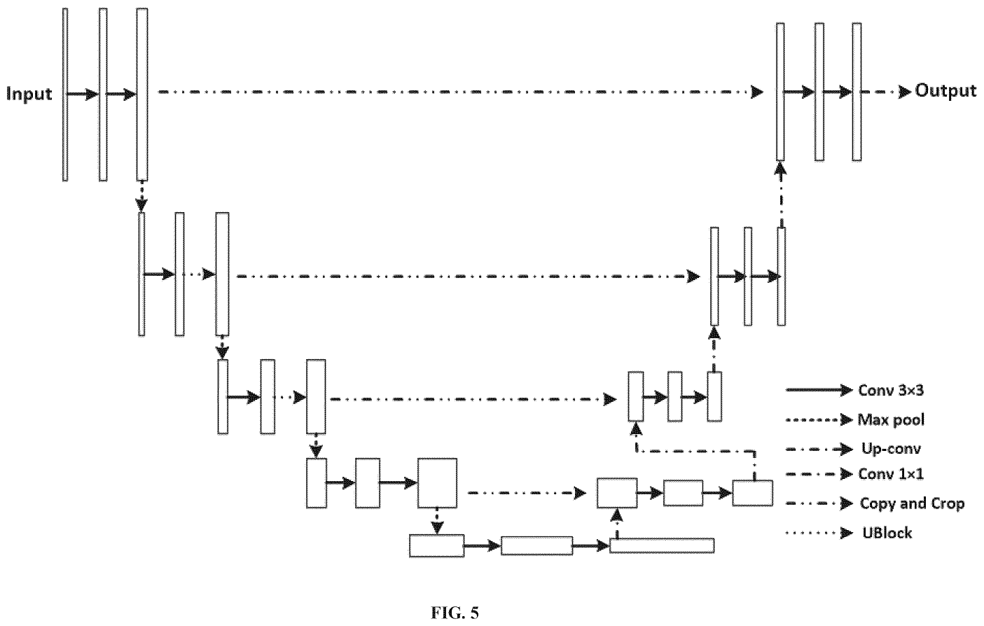

Specifically, as shown in FIG. 4, the UBlock structure is a multi-branch structure with four branches. In the first branch, a regular convolutional layer is connected for feature extraction. In the second branch, three regular convolutional layers are first connected in series, followed by a deep residual shrinkage network. The deep residual shrinkage network improves upon residual networks by inserting a soft threshold function into a deep structure as a non-linear transformation layer to effectively eliminate noise-related features. In the third branch, three inverted residual structures are connected in series, followed by a Squeeze-and-Excitation (SE) channel attention mechanism. The core of the inverted residual structure is deep convolution, and the core of deep convolution is that the number of input and output feature matrix channels is equal to the number of convolutional kernels, thereby significantly reducing the amount of model computation and the quantity of parameters. The fourth branch starts with a global max-pooling layer to extract local features of the network, followed by a regular convolutional layer to adjust channel dimensions. The outputs of the four branches are merged to integrate feature information from different scales, thereby enhancing the feature extraction capability of the network.

Referring to FIG. 5, the optimized UNet network model includes an encoder and a decoder in sequence. The encoder includes a plurality of convolutional layers and optimized UBlock structures for deep feature extraction from images, with deeper layers capturing more semantic information. The decoder consists of a plurality of convolutional layers to further extract image feature information and fuse feature information from different scales, thereby enchanting the feature representation capability.

For the captured images, the Labelme tool is used to annotate all images, generating annotated images for model training. The original images and annotation information are input into the model, which calculates loss values between model-predicted results and ground truth results through forward propagation via a series of linear and non-linear transformations on the input data. A cross-entropy loss function is used to compare the model-predicted results with the actual labels to compute the loss values, guiding model parameter updates. After the loss values are obtained, through backpropagation, the model is derived according to the loss function and the obtained gradient information is used to update the model parameters. The next round of training is performed after the parameters are updated, until the model loss values no longer decrease. During the training process, the model parameters are updated by minimizing the cross-entropy loss function. Specifically, an optimization algorithm such as stochastic gradient descent is used to solve for optimal parameters, and the model is updated iteratively. In this way, during the training process, the model will gradually learn more accurate and robust classification rules, thus improving the classification performance. After the model training is completed, the trained model weight file is obtained, and according to the changed weight file, segmented leaf information will be obtained by inputting the target image to be segmented.

### Embodiment 2

This embodiment of the present disclosure provides a system for calculating a leaf area of a plant, including: an image obtaining module, a segmentation module, and a calculation module.

The image obtaining module is configured to obtain a leaf image of a target plant on a planned path, where the planned path is a path determined based on a DWA path planning algorithm.

The segmentation module is configured to segment the leaf image by using a UNet model, to obtain a leaf segmentation image.

The calculation module is configured to calculate a leaf area based on the leaf segmentation image.

### Embodiment 3

This embodiment of the present disclosure provides an electronic device, including a memory and a processor. The memory is configured to store a computer program, and the processor runs the computer program to enable the electronic device to execute the method for calculating a leaf area of a plant in Embodiment 1.

In an embodiment, the memory is a computer-readable storage medium.

The surface of plant leaves is a non-closed curved surface, significantly increasing the difficulty of area calculation. A ground robot equipped with an RGB camera is used to capture images of plant leaves, and training is performed with an optimized semantic segmentation model. The optimized semantic segmentation model can segment leaves of dwarf plants quickly and accurately, and then calculate the segmented leaf area, thereby greatly enhancing work efficiency.

The present disclosure optimizes the DWA local path planning algorithm to accelerate path planning speed. It also trains image data, integrating semantic and scale-inconsistent features to enhance the feature extraction capability of the network model, thereby improving the accuracy of calculation of the leaf area of the plant.

Each embodiment in the description is described in a progressive mode, each embodiment focuses on differences from other embodiments, and references can be made to each other for the same and similar parts between embodiments. Since the system disclosed in an embodiment corresponds to the method disclosed in an embodiment, the description is relatively simple, and for related contents, references can be made to the description of the method.

Particular examples are used herein for illustration of principles and implementation modes of the present disclosure. The descriptions of the above embodiments are merely used for assisting in understanding the method of the present disclosure and its core ideas. In addition, those of ordinary skill in the art can make various modifications in terms of particular implementation modes and the scope of the present disclosure in accordance with the ideas of the present disclosure. In conclusion, the content of the description shall not be construed as limitations to the present disclosure.

What is claimed is:

1. A method for calculating a leaf area of a plant, comprising:
obtaining a leaf image of a target plant on a planned path, wherein the planned path is a path determined based on a dynamic window approach (DWA) path planning algorithm;
segmenting the leaf image by using a UNet model, to obtain a leaf segmentation image, wherein the UNet model comprises an encoder, a decoder, and a trained segmentation network that are connected to each other; and
calculating a leaf area based on the leaf segmentation image.

2. The method for calculating a leaf area of a plant according to claim 1, wherein the leaf image is an RGB image captured by using an RGB camera mounted on a target robot.

3. The method for calculating a leaf area of a plant according to claim 2, wherein a process for determining the planned path comprises:
determining a travel route of the target robot, wherein the travel route is determined by a line connecting a starting point and a target point;
obtaining travel data of the target robot on the travel route in real time in a form of a dynamic window, wherein the travel data comprises obstacle position data, a travel direction, and a travel speed;
determining a trajectory function based on the DWA path planning algorithm; and
determining the planned path based on the travel data and the trajectory function.

4. The method for calculating a leaf area of a plant according to claim 3, wherein an expression of the trajectory function is as follows:
$$G ( v , w ) = σ ( α * heading ( v , w ) + β * d ist ( v , w ) + γ * velocity ( v , w ) ) ;$$
wherein G(v, w) is the trajectory function; v is the travel speed; w is an angular velocity of travel; σ is a first weight coefficient; α is a second weight coefficient; β is a third weight coefficient; γ is a fourth weight coefficient; heading(v, w) is an azimuth function; velocity(v, w) is a linear velocity of the target robot; and dist(v, w) is a distance from the target robot to an obstacle.

5. The method for calculating a leaf area of a plant according to claim 1, wherein the segmenting the leaf image by using the UNet model to obtain the leaf segmentation image specifically comprises:
extracting, by the encoder, features of the leaf image, to obtain image feature information;
performing, by the decoder, data fusion based on the image feature information, to obtain fused feature data; and
segmenting, by the trained segmentation network, the fused feature data, to obtain the leaf segmentation image.

6. The method for calculating a leaf area of a plant according to claim 5, wherein a process for determining the UNet model comprises:
obtaining training data, wherein the training data comprises: leaf images for training and leaf segmentation images corresponding to the leaf images for training;
extracting, by the encoder, features from the leaf images for training, to obtain image feature information for training;
performing data fusion based on the image feature information for training, to obtain fused feature data for training;
constructing a segmentation network;
inputting the fused feature data for training into the segmentation network, updating and optimizing model parameters by using a stochastic gradient descent method with an objective of minimizing a loss value, to obtain a trained segmentation network, wherein the model parameters comprise weight values; the loss value is determined using a cross-entropy loss function based on a difference between output data of the segmentation network and the leaf segmentation images corresponding to the leaf images for training; and
connecting the encoder, the decoder, and the trained segmentation network to form the UNet model.

7. The method for calculating a leaf area of a plant according to claim 1, wherein the calculating a leaf area based on the leaf segmentation image specifically comprises:
extracting a contour of the leaf segmentation image to obtain a leaf contour;
converting the leaf contour into a binary image;
performing morphological processing on the binary image, removing noise, and eliminating a blank area, to obtain a processed image;
performing connected component analysis on the processed image to obtain a leaf region; and
determining the leaf area based on the obtained leaf region.

8. A system for calculating a leaf area of a plant, comprising:
an image obtaining module, configured to obtain a leaf image of a target plant on a planned path, wherein the planned path is a path determined based on a dynamic window approach (DWA) path planning algorithm;
a segmentation module, configured to segment the leaf image by using a UNet model, to obtain a leaf segmentation image; and
a calculation module, configured to calculate a leaf area based on the leaf segmentation image.

9. An electronic device, comprising a memory and a processor, wherein the memory is configured to store a computer program, and the processor runs the computer program to enable the electronic device to implement the method for calculating a leaf area of a plant according to claim 1.

10. The electronic device according to claim 9, wherein the memory is a computer-readable storage medium.

11. The electronic device according to claim 9, wherein the leaf image is an RGB image captured by using an RGB camera mounted on a target robot.

12. The electronic device according to claim 11, wherein a process for determining the planned path comprises:
determining a travel route of the target robot, wherein the travel route is determined by a line connecting a starting point and a target point;
obtaining travel data of the target robot on the travel route in real time in a form of a dynamic window, wherein the travel data comprises obstacle position data, a travel direction, and a travel speed;
determining a trajectory function based on the DWA path planning algorithm; and
determining the planned path based on the travel data and the trajectory function.

13. The electronic device according to claim 12, wherein an expression of the trajectory function is as follows:
$$G ( v , w ) = σ ( α * heading ( v , w ) + β * d ist ( v , w ) + γ * velocity ( v , w ) ) ;$$
wherein G(v, w) is the trajectory function; v is the travel speed; w is an angular velocity of travel; σ is a first weight coefficient; α is a second weight coefficient; β is a third weight coefficient; γ is a fourth weight coefficient; heading(v, w) is an azimuth function; velocity(v, w) is a linear velocity of the target robot; and dist(v, w) is a distance from the target robot to an obstacle.

14. The electronic device according to claim 9, wherein the segmenting the leaf image by using the UNet model to obtain the leaf segmentation image specifically comprises:
extracting, by the encoder, features of the leaf image, to obtain image feature information;
performing, by the decoder, data fusion based on the image feature information, to obtain fused feature data; and
segmenting, by the trained segmentation network, the fused feature data, to obtain the leaf segmentation image.

15. The electronic device according to claim 14, wherein a process for determining the UNet model comprises:
obtaining training data, wherein the training data comprises: leaf images for training and leaf segmentation images corresponding to the leaf images for training;
extracting, by the encoder, features from the leaf images for training, to obtain image feature information for training;
performing data fusion based on the image feature information for training, to obtain fused feature data for training;
constructing a segmentation network;
inputting the fused feature data for training into the segmentation network, updating and optimizing model parameters by using a stochastic gradient descent method with an objective of minimizing a loss value, to obtain a trained segmentation network, wherein the model parameters comprise weight values; the loss value is determined using a cross-entropy loss function based on a difference between output data of the segmentation network and the leaf segmentation images corresponding to the leaf images for training; and
connecting the encoder, the decoder, and the trained segmentation network to form the UNet model.

16. The electronic device according to claim 9, wherein the calculating a leaf area based on the leaf segmentation image specifically comprises:
extracting a contour of the leaf segmentation image to obtain a leaf contour;
converting the leaf contour into a binary image;
performing morphological processing on the binary image, removing noise, and eliminating a blank area, to obtain a processed image;
performing connected component analysis on the processed image to obtain a leaf region; and
determining the leaf area based on the obtained leaf region.

17. The electronic device according to claim 11, wherein the memory is a computer-readable storage medium.

18. The electronic device according to claim 12, wherein the memory is a computer-readable storage medium.

19. The electronic device according to claim 13, wherein the memory is a computer-readable storage medium.

20. The electronic device according to claim 14, wherein the memory is a computer-readable storage medium.
